(19) United States
(12) Patent Application Publication
(10) Pub. No.: US 2024/0286500 A1
(43) Pub. Date: Aug. 29, 2024

(54) CONTROL DEVICE FOR POWER RECEIVING DEVICE

(71) Applicant: TOYOTA JIDOSHA KABUSHIKI KAISHA, Toyota-shi (JP)

(72) Inventors: Toshiya HASHIMOTO, Miyoshi-shi (JP); Masato MAEMURA, Nisshin-shi (JP); Ryosuke IKEMURA, Susono-shi (JP); Shogo TSUGE, Fuji-shi (JP)

(73) Assignee: TOYOTA JIDOSHA KABUSHIKI KAISHA, Toyota-shi (JP)

(21) Appl. No.: 18/533,821

(22) Filed: Dec. 8, 2023

(51) Int. Cl. B60L 53/126; B60L 53/39; H02J 50/12; H02J 50/80

(52) U.S. Cl. CPC B60L 53/126; B60L 53/39; H02J 50/12; H02J 50/80

(57) ABSTRACT

In a control device for a power receiving device that is equipped with a power receiving coil that receives power contactlessly transmitted from a power transmitting coil of a power transmitting device, a switching element provided between the power receiving coil and a load is operated to perform a switching operation to control the output terminal of the power receiving coil. When executing the short-circuit mode that short-circuits between the two, the short-circuit mode is executed so as to avoid a region where the phase of the current in the inverter of the power transmission device is advanced.

### CROSS-REFERENCE TO RELATED APPLICATION

This application claims priority to Japanese Patent Application No. 2023-030359 filed on Feb. 28, 2023, incorporated herein by reference in its entirety.

### BACKGROUND

### 1. Technical Field

The present disclosure relates to a control device for a power receiving device.

### 2. Description of Related Art

Japanese Unexamined Patent Application Publication No. 2010-233364 (JP 2010-233364 A) describes a wireless power transmission system that transmits power from a power transmitting device to a power receiving device in a contactless manner. In the wireless power transmission system, the power receiving device is provided with a rectifier circuit that rectifies the alternating current (AC) voltage of a secondary coil, and short-circuiting means that can short-circuit the secondary coil.

### SUMMARY

In an inverter on the power transmitting side, when an output voltage rises due to switching operation, and an output current with the same sign as the output voltage (turn-on current is positive) flows, a switching operation is performed to raise the output voltage in a state in which a current in the opposite direction (recovery current) flows through a diode. In this case, the load on an element increases, causing the diode and the switching element to generate heat and noise. In the wireless power transmission system, when a load on the power receiving side is to be protected, heat generation and noise from the element are issues in the case where the turn-on current on the power transmitting side is positive.

The present disclosure has been made in view of the above circumstances, and it is an object of the present disclosure to provide a control device for a power receiving device that can protect a load on a power receiving side and suppress heat generation and noise of an element on a power transmitting side.

The present disclosure provides
a control device for a power receiving device including a power receiving coil that receives power transmitted from a power transmitting coil of the power transmitting device in a contactless manner. In the control device,
when the control device performs a short-circuit mode in which a switching element provided between the power receiving coil and a load is operated to short-circuit a portion between output terminals of the power receiving coil, the control device performs the short-circuit mode such that a region in which a phase of a current in an inverter of the power transmitting device is advanced is avoided.

According to this configuration, the control device performs the short-circuit mode on a power receiving side such that the region in which the phase of the current in the inverter on a power transmitting side is advanced is avoided. Therefore, it is possible to avoid a turn-on current on a power transmitting side becoming positive. Accordingly, it is possible to protect a load on the power receiving side, and suppress the heat generation and noise of an element on the power transmitting side.

Further, the control device may determine a switching timing of the switching element in the short-circuit mode such that, by executing the short-circuit mode, the phase of the current of the inverter is shifted in a direction in which the phase of the current of the inverter is delayed.

According to this configuration, it is possible to control the switching timing in the short circuit mode such that a phase shift occurs in the direction in which the phase of the current of the inverter is delayed.

Further, when the control device performs the short-circuit mode, the control device may control a swing timing of the switching element in the short-circuit mode such that a left side of a voltage rectangular wave on a power receiving side is trimmed more than a right side of the voltage rectangular wave on the power receiving side is trimmed.

According to this configuration, it is possible to perform the short-circuit mode such that a phase shift occurs in the direction in which the phase of the current of the inverter is delayed.

In the present disclosure, the short-circuit mode is performed on the power receiving side such that the region in which the phase of the current in the inverter on the power transmitting side is advanced is avoided. Therefore, it is possible to avoid the turn-on current on the power transmitting side becoming positive. Accordingly, it is possible to protect the load on the power receiving side, and suppress the heat generation and noise of the element on the power transmitting side.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a wireless power transmission system in an embodiment;

FIG. 2 is a diagram showing the overall configuration of the wireless power transmission system;

FIG. 3 is a schematic diagram for explaining wide area wireless communication in a wireless power transmission system;

FIG. 4 is a block diagram for explaining the functional configuration of the power transmission ECU;

FIG. 5 is a block diagram for explaining the functional configuration of the vehicle ECU;

FIG. 6 is a diagram for explaining the power transfer process;

FIG. 7 is a sequence diagram showing a case where communication using wide area wireless communication is carried out between a vehicle and a supply device;

FIG. 8 is a sequence diagram showing the operation after the power supply from the supply device to the vehicle while running is completed;

FIG. 9 is a diagram for explaining the circuit configuration of the inverter and rectifier circuit shown in FIG. 2;

FIG. 10 is a waveform diagram for explaining the case where the turn-on current is positive;

FIG. 11 is a graph diagram for explaining turn-on current;

FIG. 12 is a diagram for explaining a case where there is no short circuit on the power receiving side and the turn-on current on the power transmitting side is zero;

FIG. 13 is a diagram for explaining a case where there is a short circuit on the power receiving side and the turn-on current on the power transmitting side is positive; and

FIG. 14 is a diagram for explaining a case where there is a short circuit on the power receiving side and the turn-on current on the power transmitting side becomes negative.

### DETAILED DESCRIPTION OF EMBODIMENTS

Hereinafter, a control device for a power receiving device in an embodiment of the present disclosure will be specifically described. The present disclosure is not limited to the embodiments described below.

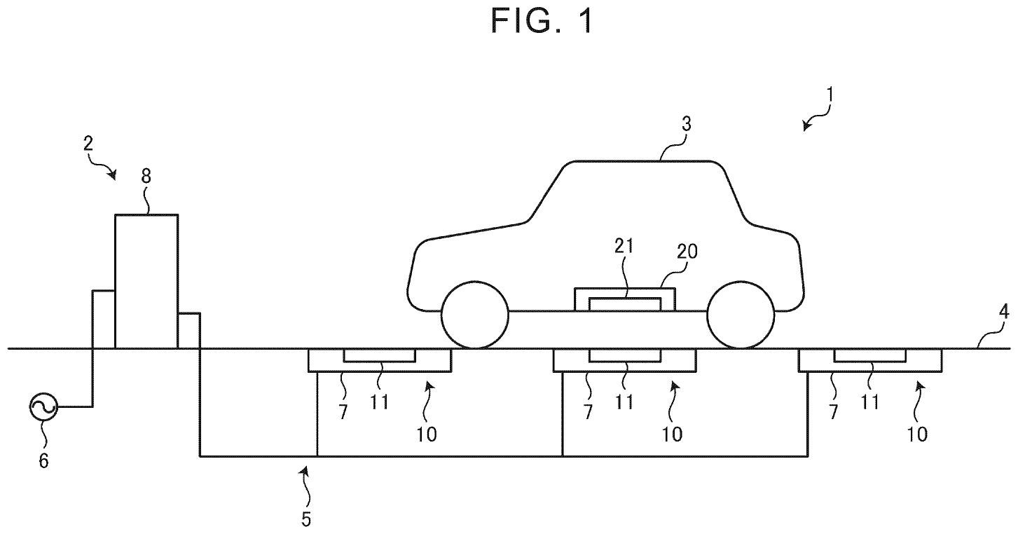

FIG. 1 is a schematic diagram showing a wireless power transmission system in an embodiment. The wireless power transmission system 1 includes a supply facility 2 and a vehicle 3. The supply facility 2 is equipment that supplies electric power to the running vehicle 3 in a non-contact manner. The vehicle 3 is an electrified vehicle that can be charged with electric power supplied from an external power source, such as a battery electric vehicle (BEV) or a plug-in hybrid electric vehicle (PHEV).

This wireless power transmission system 1 performs wireless power transmission from a supply facility 2 to a vehicle 3 by magnetic field resonance coupling (magnetic field resonance). The wireless power transmission system 1 transmits power from a supply facility 2 to a vehicle 3 running on a road 4 in a non-contact manner. In other words, the wireless power transmission system 1 transmits power by a magnetic resonance method, and realizes power feeding to the vehicle 3 while the vehicle 3 is running by using magnetic resonance coupling (magnetic resonance). The wireless power transmission system 1 can be expressed as a dynamic wireless power transfer (D-WPT) system or a magnetic field dynamic wireless power transfer (MF-D-WPT) system.

The supply facility 2 includes a supply device 5 and an AC power source 6 that supplies power to the supply device 5. The supply device 5 transmits power supplied from the AC power source 6 to the vehicle 3 in a non-contact manner. The AC power source 6 is, for example, a commercial power source. This supply device 5 includes a power transmitting device 10 having a primary coil 11.

The supply device 5 includes a segment 7 including a primary coil 11 and a management device 8 that manages the segment 7. Segment 7 is embedded within the lane of road 4. The management device 8 is installed on the side of the road 4. Segment 7 is electrically connected to management device 8. The management device 8 is electrically connected to the AC power source 6 and supplies power from the AC power source 6 to the segments 7. The segment 7 is electrically connected to the AC power source 6 via the management device 8. A plurality of segments 7 can be arranged along the lanes of the road 4. For example, as shown in FIG. 1, the supply device 5 includes three segments 7 installed in line along a lane on the road 4, and one management device 8 to which the three segments 7 are connected. The segment 7 has a function of transmitting electric power from the supply device 5 to the vehicle 3 in a contactless manner. The management device 8 has a function of controlling wireless power transmission in the segment 7.

Vehicle 3 includes power receiving device 20 having secondary coil 21. The power receiving device 20 is provided at the bottom of the vehicle 3. When the vehicle 3 travels on the road 4 on which the primary coil 11 is installed, the primary coil 11 on the ground side and the secondary coil 21 on the vehicle side face each other in the vertical direction. The wireless power transmission system 1 transmits power from the primary coil 11 of the power transmitting device 10 to the secondary coil 21 of the power receiving device 20 in a non-contact manner while the vehicle 3 is traveling on the road 4.

In this description, traveling means a state in which the vehicle 3 is located on the road 4 for traveling. While traveling, a state in which the vehicle 3 is temporarily stopped on the road 4 is also included. For example, a state in which the vehicle 3 is stopped on the road 4 due to waiting at a traffic light or the like is also included in the traveling state. On the other hand, even if the vehicle 3 is located on the road 4, for example, if the vehicle 3 is parked or stopped, it is not included in the running state.

In addition, in this explanation, the lane in which the primary coil 11 (segment 7) is embedded is referred to as the D-WPT lane, which is a part of the road 4 where wireless power transmission by the supply device 5 is possible. This is sometimes referred to as a D-WPT charging site. In the D-WPT lane and the D-WPT charging site, a plurality of primary coils 11 (a plurality of segments 7) are installed in line in the traveling direction of the vehicle 3 over a predetermined section of the road 4.

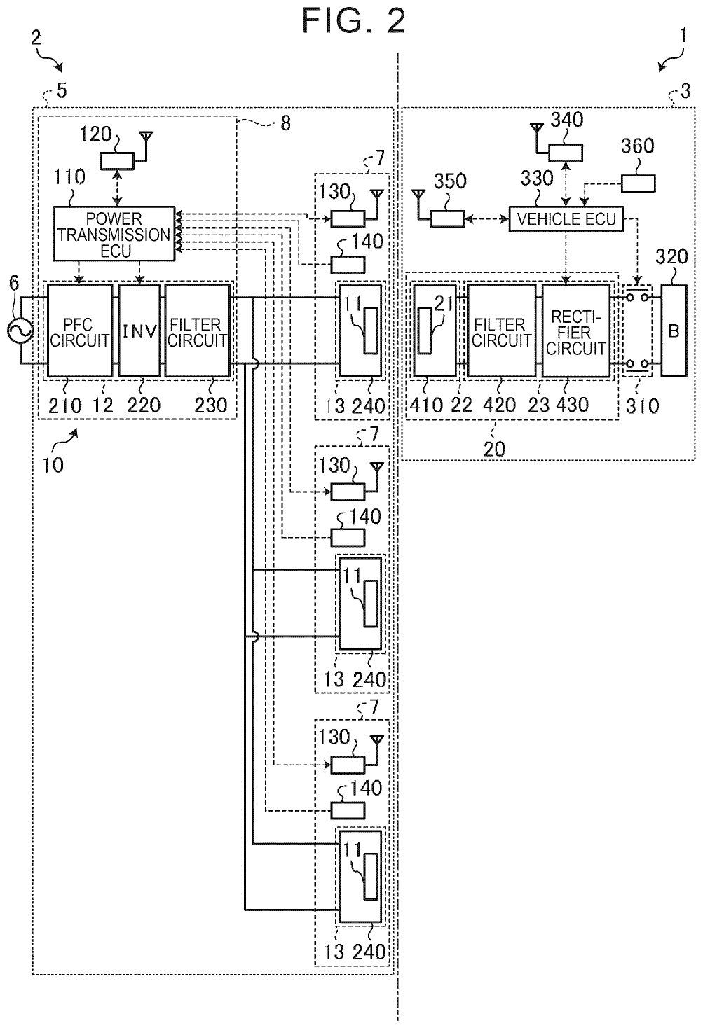

FIG. 2 is a diagram showing the overall configuration of the wireless power transmission system. In the supply facility 2, a supply device 5 and an AC power source 6 are electrically connected. In the supply device 5, the segment 7 and the management device 8 are electrically connected.

The supply device 5 includes a configuration provided in the management device 8 and a configuration provided in the segment 7. The supply device 5 includes a power transmitting device 10, a power transmission electronic control unit (power transmission ECU) 110, a first communication device 120, a second communication device 130, and a foreign object detection device 140.

Power transmitting device 10 includes an electric circuit connected to AC power source 6. The power transmitting device 10 includes a power factor collection circuit (PFC circuit) 210, an inverter (INV) 220, a filter circuit 230, and a power transmitting side resonance circuit 240.

PFC circuit 210 improves the power factor of AC power input from AC power source 6, converts the AC power into direct current (DC) power, and outputs the DC power to inverter 220. This PFC circuit 210 is configured including an AC/DC converter. PFC circuit 210 is electrically connected to AC power source 6.

Inverter 220 converts DC power input from PFC circuit 210 into AC power. Each switching element of the inverter 220 is composed of an insulated gate bipolar transistor (IGBT), a metal-oxide-semiconductor field effect transistor (MOSFET), etc., and performs a switching operation in response to a control signal from the power transmission ECU 110. For example, the driving frequency of inverter 220 is 85 kHz. Inverter 220 outputs the converted AC power to filter circuit 230.

The filter circuit 230 removes noise contained in the alternating current input from the inverter 220 and supplies the noise-free alternating current power to the power transmitting side resonance circuit 240. The filter circuit 230 is an LC filter that combines a coil and a capacitor. For example, the filter circuit 230 is constituted by a T-type filter in which two coils and one capacitor are arranged in a T-shape. The PFC circuit 210, the inverter 220, and the filter circuit 230 constitute the power conversion unit 12 of the power transmitting device 10.

The power transmitting side resonance circuit 240 is a power transmission unit that transmits the AC power supplied from the filter circuit 230 to the power receiving device 20 in a non-contact manner. When AC power is supplied from the filter circuit 230 to the transmitting side resonance circuit 240, current flows through the primary coil 11, and a magnetic field for power transmission is generated.

The power transmitting side resonance circuit 240 includes a primary coil 11 and a resonant capacitor. The primary coil 11 is a power transmission coil. This resonance capacitor is connected in series to one end of the primary coil 11 and adjusts the resonance frequency of the power transmitting side resonance circuit 240. This resonant frequency is between 10 kHz and 100 GHz, preferably 85 kHz. For example, the power transmitting device 10 is configured such that the resonance frequency of the power transmitting side resonance circuit 240 and the drive frequency of the inverter 220 match. The power transmitting side resonance circuit 240 constitutes the primary device 13 of the power transmitting device 10.

The power transmitting device 10 includes a power conversion unit 12 and a primary device 13. Power conversion unit 12 includes a PFC circuit 210, an inverter 220, and a filter circuit 230. The primary device 13 includes a transmitting side resonance circuit 240. The power transmitting device 10 has a configuration in which the power conversion unit 12 is provided in the management device 8 and the primary device 13 is provided in the segment 7.

In the supply device 5, the power conversion unit 12 of the power transmitting device 10, the power transmission ECU 110, and the first communication device 120 are provided in the management device 8, and the primary device 13 of the power transmitting device 10 and the second communication device 130 are provided, and a foreign object detection device 140 are provided in the segment 7.

The power transmission ECU 110 is an electronic control device that controls the supply device 5. Power transmission ECU 110 includes a processor and a memory. The processor includes a central processing unit (CPU), a digital signal processor (DSP), a field-programmable gate array (FPGA), and the like. Memory is a main storage device, and includes random access memory (RAM), read only memory (ROM), and the like. The power transmission ECU 110 loads a program stored in a storage unit into a work area of a memory (main storage unit) and executes it, controls each component through the execution of the program to achieve a function that meets a predetermined purpose. The storage unit includes a recording medium such as an erasable programmable ROM (EPROM), a hard disk drive (HDD), and a removable medium. Examples of removable media include disc recording media such as universal serial bus memory (USB memory), compact disc (CD), digital versatile disc (DVD), and Blu-ray (registered trademark) Disc (BD). The storage unit can store an operating system (OS), various programs, various tables, various databases, and the like. Signals from various sensors are input to the power transmission ECU 110. A signal from the foreign object detection device 140 is input to the power transmission ECU 110. Power transmission ECU 110 then executes various controls based on signals input from various sensors.

For example, power transmission ECU 110 executes power control to adjust power for transmission. In power control, the power transmission ECU 110 controls the power transmitting device 10. The power transmission ECU 110 outputs a control signal to the power conversion unit 12 in order to control the power supplied from the power conversion unit 12 to the primary device 13. The power transmission ECU 110 controls the switching elements included in the PFC circuit 210 to adjust the power for transmission, and controls the switching elements included in the inverter 220 to adjust the power for transmission.

The power transmission ECU 110 also executes communication control for controlling communication with the vehicle 3. In communication control, power transmission ECU 110 controls first communication device 120 and second communication device 130.

The first communication device 120 is a ground-side communication device that performs wide area wireless communication. The first communication device 120 performs wireless communication with, among vehicles 3 that are traveling on the road 4, a vehicle 3 that is before approaching the WPT lane. The state before approaching the WPT lane means that the vehicle 3 is in a position where short-range wireless communication cannot be performed with the supply device 5.

Wide area wireless communication is communication with a communication distance of 10 meters to 10 kilometers. Wide area wireless communication has a longer communication distance than narrow area wireless communication. As the wide area wireless communication, various types of wireless communication having a long communication distance can be used. For example, communication conforming to communication standards such as 3GPP (registered trademark), 4G, LTE, 5G, and WiMAX established by IEEE is used for wide area wireless communication. In the wireless power transmission system 1, vehicle information linked to vehicle identification information (vehicle ID) is transmitted from the vehicle 3 to the supply device 5 using wide area wireless communication.

The second communication device 130 is a ground-side communication device that performs short-range wireless communication. The second communication device 130 performs wireless communication with a vehicle 3 that is approaching or entering the WPT lane among the vehicles 3 traveling on the road 4. A state in which the vehicle 3 is close to the WPT lane means that the vehicle 3 is in a position where short-range wireless communication can be performed with the supply device 5.

Short-range wireless communication is communication with a communication distance of less than 10 meters. Short-range wireless communication is communication that has a shorter communication distance than wide-area wireless communication. As the short-range wireless communication, various short-range wireless communications with short communication distances can be used. For example, communication conforming to any communication standard established by IEEE, ISO, IEC, etc. is used for short-range wireless communication. As an example, Wi-Fi (registered trademark), Bluetooth (registered trademark), ZigBee (registered trademark), etc. are used for short-range wireless communication. Alternatively, radio frequency identification (RFID), dedicated short range communication (DSRC), etc. may be used as a technique for performing short range wireless communication. In the wireless power transmission system 1, vehicle identification information and the like are transmitted from the vehicle 3 to the supply device 5 using short-range wireless communication.

The foreign object detection device 140 detects metal foreign objects, living organisms, etc. present above the primary coil 11. The foreign object detection device 140 is composed of, for example, a sensor coil and an imaging device installed on the ground. The foreign object detection device 140 is used to perform a foreign object detection function (FOD) and a living object protection function (LOP) in the wireless power transmission system 1.

In the supply device 5, the configuration of the power transmitting device 10 is divided into segments 7 and management device 8, and three segments 7 are connected to one management device 8. The power transmitting device 10 is configured such that one inverter supplies power to three power transmitting side resonance circuits 240. Further, in the supply device 5, signals from each segment 7 are input to the management device 8. Signals from second communication device 130 and foreign object detection device 140 provided in the first segment are input to power transmission ECU 110. Similarly, signals from second communication device 130 and foreign object detection device 140 provided in the second segment are input to power transmission ECU 110. Signals from second communication device 130 and foreign object detection device 140 provided in the third segment are input to power transmission ECU 110. The power transmission ECU 110 can grasp the state of each segment 7 based on the signal input from each segment 7.

The vehicle 3 includes a power receiving device 20, a charging relay 310, a battery 320, a vehicle ECU 330, a third communication device 340, a fourth communication device 350, and a global positioning system receiver (GPS receiver) 360.

The power receiving device 20 supplies the power received from the power transmitting device 10 to the battery 320. Power receiving device 20 is electrically connected to battery 320 via charging relay 310. The power receiving device 20 includes a power receiving side resonance circuit 410, a filter circuit 420, and a rectifier circuit 430.

The power receiving side resonance circuit 410 is a power receiving unit that receives power transmitted contactlessly from the power transmitting device 10. The power receiving side resonance circuit 410 is configured by a power receiving side resonant circuit including the secondary coil 21 and a resonant capacitor. The secondary coil 21 is a power receiving coil that receives power transmitted from the primary coil 11 in a non-contact manner. This resonant capacitor is connected in series to one end of the secondary coil 21 and adjusts the resonant frequency of the power receiving side resonance circuit 410. The resonance frequency of the power receiving side resonance circuit 410 is determined to match the resonance frequency of the power transmitting side resonance circuit 240.

The resonance frequency of the power receiving side resonance circuit 410 is the same as the resonance frequency of the power transmitting side resonance circuit 240. Therefore, when a magnetic field is generated by the power transmitting side resonance circuit 240 while the power receiving side resonance circuit 410 faces the power transmitting side resonance circuit 240, the vibration of the magnetic field is transmitted to the power receiving side resonance circuit 410. The primary coil 11 and the secondary coil 21 enter into a resonant state. When an induced current flows through the secondary coil 21 due to electromagnetic induction, an induced electromotive force is generated in the power receiving side resonance circuit 410. The power receiving side resonance circuit 410 receives the power transmitted in a contactless manner from the power transmitting side resonance circuit 240 in this manner. The power receiving side resonance circuit 410 then supplies the power received from the power transmitting side resonance circuit 240 to the filter circuit 420. The power receiving side resonance circuit 410 constitutes the secondary device 22 of the power receiving device 20.

The filter circuit 420 removes noise contained in the alternating current input from the power receiving side resonance circuit 410 and outputs the noise-removed alternating current power to the rectifier circuit 430. Filter circuit 420 is an LC filter that combines a coil and a capacitor. For example, the filter circuit 420 is composed of a T-type filter in which two coils and one capacitor are arranged in a T-shape.

The rectifier circuit 430 converts the AC power input from the filter circuit 420 into DC power and outputs the DC power to the battery 320. The rectifier circuit 430 is configured, for example, by a full-bridge circuit in which four diodes are connected as rectifiers in a full-bridge manner. A switching element is connected in parallel to each diode of the rectifier circuit 430. Each switching element of the rectifier circuit 430 is constituted by an IGBT, and performs a switching operation in response to a control signal from the vehicle ECU 330. Rectifier circuit 430 supplies the converted DC power to battery 320. The filter circuit 420 and the rectifier circuit 430 constitute the power conversion unit 23 of the power receiving device 20.

The power receiving device 20 includes a secondary device 22 and a power conversion unit 23. Secondary device 22 includes a power receiving side resonance circuit 410. Power conversion unit 23 includes a filter circuit 420 and a rectifier circuit 430.

Charging relay 310 is provided between rectifier circuit 430 and battery 320. The opening/closing state of charging relay 310 is controlled by vehicle ECU 330. When the battery 320 is charged by the power transmitting device 10, the charging relay 310 is controlled to be closed. When charging relay 310 is closed, rectifying circuit 430 and battery 320 are electrically connected. When charging relay 310 is open, the connection between rectifier circuit 430 and battery 320 is disabled. For example, when charging relay 310 is in an open state, vehicle 3 does not request power supply.

The battery 320 is a rechargeable DC power supply, and is composed of, for example, a lithium ion battery or a nickel metal hydride battery. The battery 320 stores power supplied from the power transmitting device 10 to the power receiving device 20. Also, the battery 320 can supply electric power to the driving motor of the vehicle 3. The battery 320 is electrically connected to the driving motor via a power control unit (PCU). The PCU is a power conversion device that converts the DC power of the battery 320 into AC power and supplies it to the driving motor. Each switching element of the PCU is composed of an IGBT, and performs a switching operation in response to control signals from the vehicle ECU 330 and the like.

A vehicle ECU 330 is an electronic control device that controls the vehicle 3. The vehicle ECU 330 has the same hardware configuration as the power transmission ECU 110. Signals from various sensors mounted on the vehicle 3 are input to the vehicle ECU 330. A positioning signal received by the GPS receiver 360 is also input to the vehicle ECU 330. Vehicle ECU 330 can acquire current position information of vehicle 3 from GPS receiver 360. Vehicle ECU 330 then executes various controls based on signals input from various sensors.

For example, the vehicle ECU 330 performs contactless charging control to transmit power from the primary coil 11 to the secondary coil 21 in a contactless manner and store the power received by the secondary coil 21 in the battery 320. In non-contact charging control, vehicle ECU 330 controls rectifier circuit 430, charging relay 310, third communication device 340, and fourth communication device 350. The non-contact charging control includes power control that controls charging power and communication control that controls communication with the supply device 5. In power control, vehicle ECU 330 controls switching elements included in rectifier circuit 430 to adjust the power (charging power) supplied from power receiving device 20 to battery 320. In communication control, vehicle ECU 330 controls third communication device 340 and fourth communication device 350.

The third communication device 340 is a vehicle-side communication device that performs wide area wireless communication. The third communication device 340 wirelessly communicates with the first communication device 120 of the supply device 5 before the vehicle 3 traveling on the road 4 approaches the WPT lane. Wide area wireless communication is two-way wireless communication. Communication between the first communication device 120 and the third communication device 340 is performed by high-speed wireless communication.

The fourth communication device 350 is a vehicle-side communication device that performs short-range wireless communication. The fourth communication device 350 wirelessly communicates with the second communication device 130 of the supply device 5 when the vehicle 3 approaches or enters the WPT lane. Short-range wireless communication is unidirectional wireless signaling. Unidirectional wireless signaling is point to point signaling (P2PS). P2PS is used to notify vehicle identification information from the vehicle 3 to the supply device 5 in each activity of pairing, alignment check, magnetic coupling check, execution of power transfer, and termination of power transfer. P2PS can also be used as a lateral alignment check. The lateral direction refers to the width direction of the lane and the width direction of the vehicle 3.

GPS receiver 360 detects the current position of vehicle 3 based on positioning information obtained from a plurality of positioning satellites. Current position information of vehicle 3 detected by GPS receiver 360 is transmitted to vehicle ECU 330.

Note that in the supply device 5, the filter circuit 230 may be included in the management device 8 instead of the segment 7. That is, the filter circuit 230 may be installed on the side of the road 4. In this case, the power conversion unit 12 includes a PFC circuit 210, an inverter 220, and a filter circuit 230, and the primary device 13 includes a power transmitting side resonance circuit 240.

Moreover, the filter circuit 230 may be provided for each primary coil 11 individually, or may be provided collectively for a plurality of primary coils 11.

Moreover, the filter circuit 230 is not limited to a T-type filter, and may be, for example, a band-pass filter in which a coil and a capacitor are connected in series. This is the same for the filter circuit 420 of the vehicle 3 as well.

Further, in the power transmitting device 10, when the inverter 220 is connected to the plurality of primary coils 11, each primary device 13 may be provided with a switch for switching the primary coil 11 to be energized. This changeover switch may be provided in the management device 8 beside the road 4, or may be provided near the primary coil 11.

Further, the power transmitting side resonance circuit 240 is not limited to a configuration in which the primary coil 11 and the resonant capacitor are connected in series. The primary coil 11 and resonant capacitor may be connected in parallel, or may be a combination of parallel and series. In short, the power transmitting side resonance circuit 240 may be configured such that the resonance frequency of the power transmitting side resonance circuit 240 matches the drive frequency of the inverter 220, and the connection relationship of its components is not particularly limited. The same applies to the power receiving side resonance circuit 410 of the vehicle 3.

Further, the drive frequency of inverter 220 is not limited to 85 kHz, and may be a frequency around 85 kHz. In short, the driving frequency of inverter 220 may be a predetermined frequency band including 85 kHz.

Further, the power transmitting device 10 may have a configuration in which a plurality of inverters 220 are connected to the output side power line (DC power line) of the PFC circuit 210.

Further, the foreign object detection device 140 may be provided not only on the ground side but also on the vehicle 3 side. For example, when the foreign object detection device on the vehicle 3 side detects a foreign object or a living body present above the primary coil 11, the power supply request can be stopped until the vehicle 3 passes the primary coil 11.

In addition, in the wireless power transmission system 1, the information transmitted from the vehicle 3 to the supply device 5 using short-range wireless communication includes, in addition to vehicle identification information, a power supply request, a power supply request value, etc. The power supply request is information indicating that power transmission from the primary coil 11 is requested. The required power supply value is a required value of the amount of power transmitted from the supply device 5 to the vehicle 3. Vehicle ECU 330 can calculate the power supply request value based on the SOC of battery 320.

Furthermore, the wireless power transmission system 1 is not limited to the method of feeding power from the ground to the vehicle 3, but can also realize a method of feeding power from the vehicle 3 to the ground. In this case, the rectifier circuit 430 can be replaced with an inverter to realize rectification during power supply and power reception.

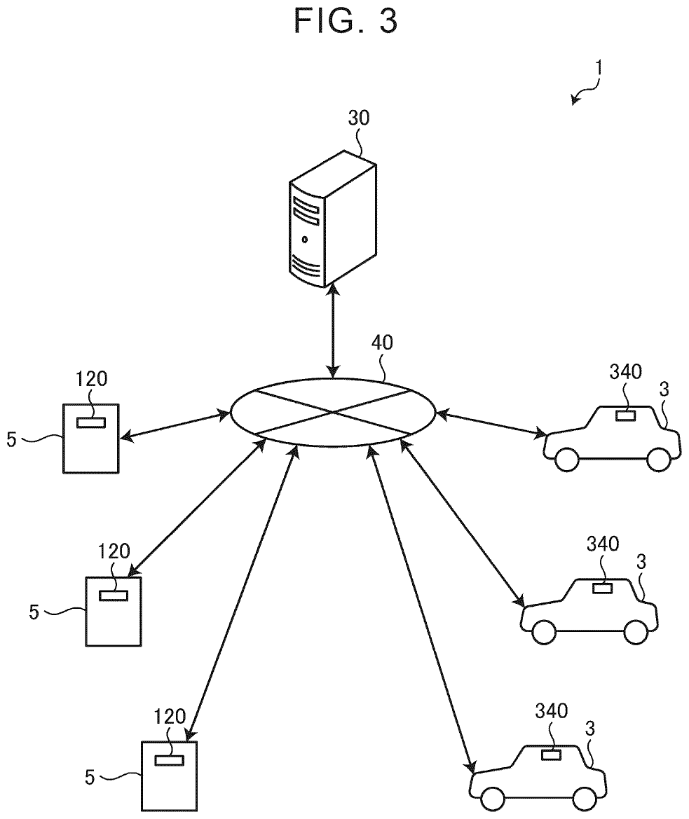

FIG. 3 is a schematic diagram for explaining wide-area wireless communication in the wireless power transmission system.

In the wireless power transmission system 1, the vehicle 3 can communicate with the server 30, and the supply device 5 can communicate with the server 30. The server 30 is connected to a network 40 and can communicate with multiple vehicles 3 and multiple supply devices 5 via the network 40. The network 40 includes a wide area network (WAN), which is a public communication network such as the Internet, a telephone communication network of a mobile phone, and the like.

The vehicle 3 connects to the network 40 by wide area wireless communication using the third communication device 340. Vehicle 3 transmits information to server 30 and receives information from server 30.

The supply device 5 connects to the network 40 by wide area wireless communication using the first communication device 120. The supply device 5 transmits information to the server 30 and receives information from the server 30.

The server 30 processes information regarding wireless power transfer between the vehicle 3 and the supply device 5. The server 30 includes a communication device and a control device. This control device has the same hardware configuration as power transmission ECU 110. The server 30 creates various lists related to wireless power transfer based on the information received from the vehicle 3 and the information received from the supply device 5. Then, the server 30 provides necessary information regarding wireless power transfer to the necessary vehicles 3 and supply devices 5 at the necessary timing based on various lists. In the wireless power transmission system 1, communication between the vehicle 3 and the supply device 5 via the server 30 is possible using wide area wireless communication. The running vehicle 3 transmits vehicle identification information (vehicle ID) to the server 30, and the server 30 transmits vehicle information linked to the vehicle identification information to the supply device 5.

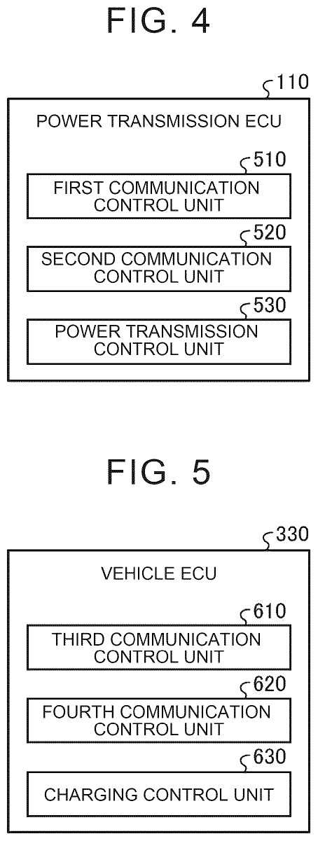

FIG. 4 is a block diagram showing the functional configuration of the power transmission ECU. Power transmission ECU 110 includes a first communication control unit 510, a second communication control unit 520, and a power transmission control unit 530.

The first communication control unit 510 executes first communication control to control the first communication device 120. The first communication control is to control wide area wireless communication on the side of the supply device 5, and controls communication of the supply device 5 using the first communication device 120. That is, the first communication control controls communication of the management device 8 of the supply device 5. The first communication control controls communication between the supply device 5 and the network 40 and controls communication between the supply device 5 and the server 30 via the network 40. The first communication control unit 510 is a supply equipment communication controller (SECC).

The second communication control unit 520 executes second communication control to control the second communication device 130. The second communication control controls short-range wireless communication on the side of the supply device 5, and controls communication of the supply device 5 using the second communication device 130. That is, the second communication control controls communication of the segment 7 of the supply device 5. The second communication control controls communication between the supply device 5 and the vehicle 3 as communication not via the network 40. The second communication control unit 520 is a primary device communication controller (PDCC).

The power transmission control unit 530 executes power transmission control to control the power transmitting device 10. Power transmission control is to control power for power transmission, and controls the power conversion unit 12 of the power transmitting device 10. Power transmission control unit 530 performs power control to control PFC circuit 210 and inverter 220.

FIG. 5 is a block diagram showing the functional configuration of the vehicle ECU. Vehicle ECU 330 includes a third communication control unit 610, a fourth communication control unit 620, and a charging control unit 630.

The third communication control unit 610 executes third communication control to control the third communication device 340. The third communication control controls wide area wireless communication on the vehicle 3 side, and controls communication of the vehicle 3 using the third communication device 340. The third communication control controls communication between the vehicle 3 and the network 40 and also controls communication between the vehicle 3 and the server 30 via the network 40. The third communication control unit 610 is an EV communication controller (EVCC).

The fourth communication control unit 620 executes fourth communication control to control the fourth communication device 350. The fourth communication control controls short-range wireless communication on the vehicle 3 side, and controls communication of the vehicle 3 using the fourth communication device 350. The fourth communication control controls communication between the vehicle 3 and the supply device 5 as communication not via the network 40. The fourth communication control unit 620 is a secondary device communication controller (SDCC).

Charging control unit 630 executes charging control to control power receiving device 20 and charging relay 310. Charging control includes power control for controlling received power in secondary device 22 and relay control for controlling the connection state between secondary device 22 and battery 320. Charging control unit 630 performs power control to control rectifier circuit 430. Charging control unit 630 executes relay control to switch the open/closed state of charging relay 310.

In the wireless power transmission system 1 configured as described above, wireless power transmission from the supply device 5 to the vehicle 3 is performed in a state where wireless communication is established between the vehicle 3 and the supply device 5. In a state in which the vehicle 3 and the supply device 5 are paired by wireless communication, power is transmitted from the ground-side primary coil 11 to the vehicle-side secondary coil 21 in a non-contact manner. Then, in the vehicle 3, charging control is performed to supply the electric power received by the secondary coil 21 to the battery 320.

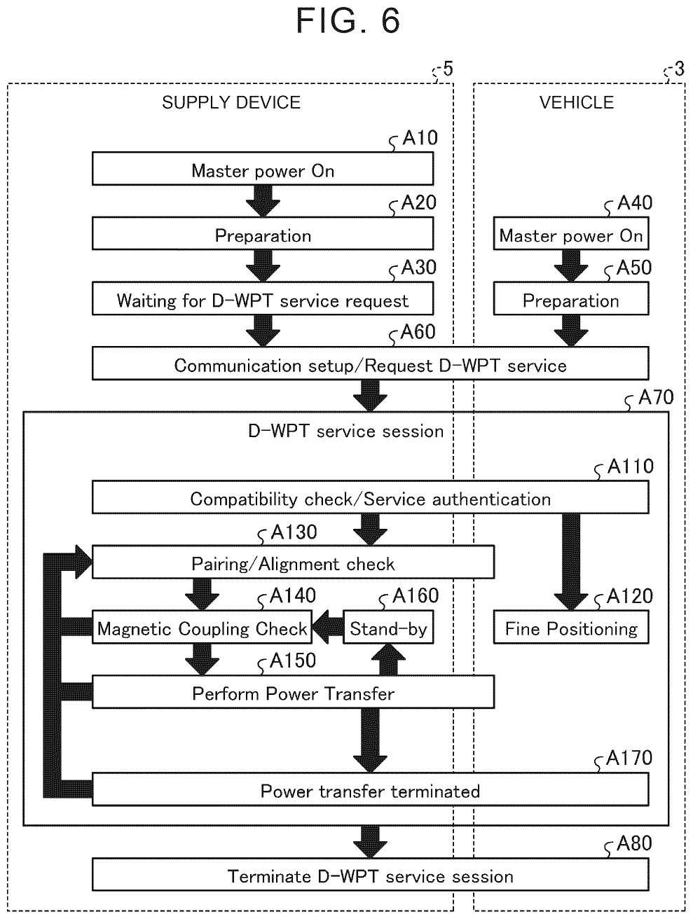

Next, the power transfer process (D-WPT process) will be explained with reference to FIG. 6. The power transfer process is structured as a chain of multiple activities and is a process derived from states and corresponding transitions.

FIG. 6 is a diagram for explaining the power transfer process. In FIG. 6, basic activities are shown to explain the power transfer process. The thick arrows shown in FIG. 6 represent transition lines. The state of the wireless power transmission system 1 in the power transfer process is represented by activities that constitute the power transfer process.

The activities that make up the power transfer process include the power transfer service session (D-WPT service session A70) which is the activity at the stage of power transmission, the activity at the stage before power transmission, and the activity at the stage after power transmission. The activities can be explained separately depending on whether or not there is communication between the supply device 5 and the vehicle 3. The activities can be divided into one that represents the state of only the supply device 5 side without communication, one that represents the state of only the vehicle 3 side without communication, and one that represents the state of both the supply device 5 and vehicle 3 that have communication.

As shown in FIG. 6, the activities include master power on state (Master poewr On) A10, Preparation A20, waiting for a request from vehicle 3 (Waiting for D-WPT service request) A30, and master power on state (Master poewr On) A40, Preparation A50, Communication setup and Request D-WPT service A60, D-WPT service session A70, and Terminate D-WPT service session A80.

Preparation A20 is the preparation state of the supply device 5. In Preparation A20, the supply device 5 performs circuit activation and safety confirmation without communication with the vehicle 3. The supply device 5 transitions to the state of Preparation A20 when the master power source enters the on state A10. If the supply device 5 activates the circuit and confirms safety in Preparation A20, the state changes to Waiting for D-WPT service request A30 from the vehicle 3. On the other hand, when there is a problem with the supply device 5, the supply device 5 notifies the vehicle 3 of information indicating that the wireless power transmission system 1 cannot be used (unusable notification) through wide area wireless communication. The first communication device 120 transmits a usage prohibition notice to the vehicle 3.

Preparation A50 is the preparation state of the vehicle 3. In Preparation A50, the vehicle 3 performs circuit activation and safety checks without communication with the supply device 5. Upon Master power On A40, the vehicle 3 transitions to the state of Preparation A50. If the vehicle 3 activates the circuit and confirms safety in Preparation A50, the state changes to Communication setup and Request D-WPT service A60. On the other hand, if there is a problem with the vehicle 3, the vehicle 3 will not start wide area wireless communication and will not perform the subsequent sequences in the D-WPT process.

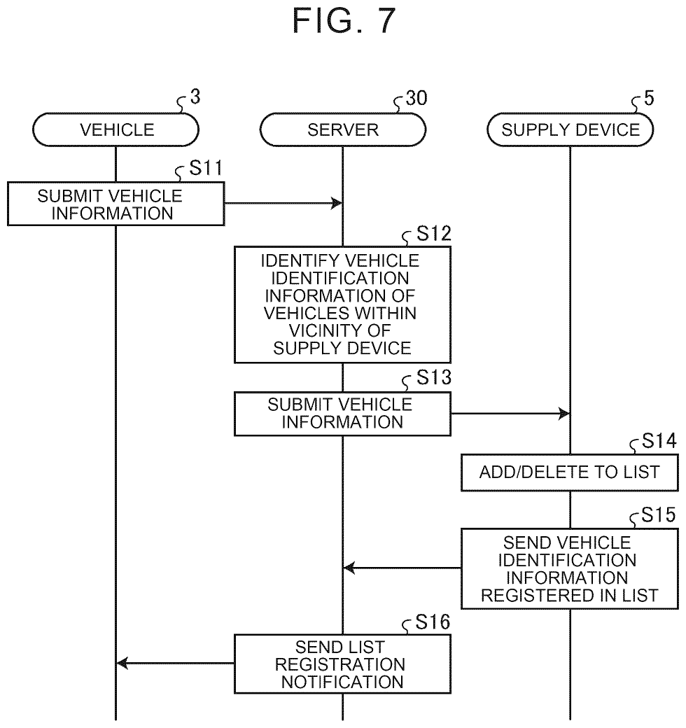

Communication setup and Request D-WPT service A60 is initiated by the vehicle ECU 330. In Communication setup and Request D-WPT service A60, vehicle ECU 330 starts wide area wireless communication. First, when the vehicle 3 transitions from Preparation A50 to Communication setup and Request D-WPT service A60, the third communication device 340 transmits a D-WPT service request signal. The third communication device 340 performs wireless communication with the first communication device 120 corresponding to the D-WPT lane into which the vehicle 3 is scheduled to enter or has entered. The first communication device 120 to communicate with is selected based on the relative positional relationship between the current position of the vehicle 3 and the position of the D-WPT lane. On the supply device 5 side, when the first communication device 120 receives the D-WPT service request signal in the state of Waiting for D-WPT service request A30 from the vehicle 3, the state transitions to Communication setup and Request D-WPT service A60. Various types of information in wide area wireless communication and P2PS communication are linked using vehicle identification information. FIG. 7 shows the processing sequence of this Communication setup and Request D-WPT service A60.

FIG. 7 is a sequence diagram showing a case where communication using wide area wireless communication is performed between the vehicle and the supply device. The vehicle 3 transmits vehicle information to the server 30 (S11). In S11, the third communication device 340 of the vehicle 3 transmits vehicle information to the server 30. The vehicle information includes vehicle identification information, various parameters of the power receiving device 20, current position information of the vehicle 3, and requested power. Vehicle ECU 330 calculates the required power based on the state of charge (SOC) of battery 320. In S11, the vehicle ECU 330 causes the third communication device 340 to transmit vehicle information at predetermined time intervals. The predetermined time is set according to the distance from the current position of the vehicle 3 to the starting point of the WPT lane. The shorter the distance from the vehicle 3 to the starting point of the WPT lane, the shorter the predetermined time interval.

When the server 30 receives the vehicle information from the vehicle 3, it specifies the vehicle identification information of the vehicle 3 located in the vicinity of the supply device 5 based on the current position information of the vehicle 3 included in the vehicle information (S12). In S12, the server 30 identifies the vehicle 3 positioned within a predetermined vicinity area from the supply device 5 based on the current position information of the vehicle 3 and the position information of the supply device 5. The neighboring area is set within, for example, 500 meters.

After identifying the vehicle identification information of the vehicle 3, the server 30 transmits the vehicle information to the supply device 5 (S13). At S13, the transmission device of the server 30 transmits vehicle information to the supply device 5.

When the supply device 5 receives the vehicle information from the server 30, it registers and deletes the vehicle identification information from the identification information list (S14). In S14, the power transmission ECU 110 registers/deletes the vehicle identification information in the identification information list so that the vehicle identification information linked to the vehicle information is registered in the identification information list without excess or deficiency.

After registering and deleting the vehicle identification information from the identification information list, the supply device 5 transmits the vehicle identification information registered in the identification information list to the server 30 (S15). At S15, the first communication device 120 of the supply device 5 transmits the vehicle identification information to the server 30.

Then, upon receiving the vehicle identification information from the supply device 5, the server 30 transmits a list registration notification to the vehicle 3 corresponding to the vehicle identification information registered in the identification information list (S16). In S16, the communication device of server 30 transmits a list registration notification to vehicle 3. The list registration notification is a notification indicating that the vehicle identification information is registered in the identification information list, and includes identification information of the supply device 5 and position information of the supply device 5.

Thus, when the vehicle 3 starts wide area wireless communication and both the supply device 5 and the vehicle 3 are in the state of Communication setup and Request D-WPT service A60, the communication setting by wide area wireless communication is successful. With the success of this communication setup, the state transitions to D-WPT service session A70.

Return to FIG. 6. In D-WPT service session A70, in a state where a communication connection is established between the supply device 5 and the vehicle 3, power is transmitted from the transmitting side resonance circuit 240 of the supply device 5 to the power receiving side resonance circuit 410 of the vehicle 3 in a non-contact manner. D-WPT service session A70 starts with successful communication setup and ends with the end of communication. When communication ends in the state of D-WPT service session A70, the state transitions to Terminate D-WPT service session A80.

At Terminate D-WPT service session A80, the vehicle 3 ends wide area wireless communication with the supply device 5. The vehicle 3 and the supply device 5 can receive a trigger for the termination of D-WPT service session A70. Then, the vehicle ECU 330 prevents the secondary device 22 and the vehicle 3 from starting D-WPT until the third communication device 340 receives the next notification (D-WPT service request signal).

Here, detailed activities of D-WPT service session A70 will be explained.

D-WPT service session A70 includes a Compatibility check and Service authentication A110, a Fine Positioning A120, and a Pairing and Alignment check A130, Magnetic Coupling Check A140, Perform Power Transfer A150, Stand-by A160, and Power transfer terminated A170.

Compatibility check and Service authentication A110 will be described. After successful communication setup, vehicle ECU 330 and power transmission ECU 110 confirm that primary device 13 and secondary device 22 are compatible. The compatibility check is performed on the supply device 5 side based on information associated with vehicle identification information acquired through communication. Check items include the minimum ground clearance of the secondary device 22, the shape type of the power receiving side resonance circuit 410, the circuit topology of the secondary device 22, the self-resonant frequency of the secondary device 22, the number of secondary coils 21, etc.

In the compatibility check and Service authentication A110, first, the vehicle 3 transmits compatibility information of the power receiving device 20 from the third communication device 340 to the supply device 5. The compatibility information of the power receiving device 20 is transmitted by wide area wireless communication. The first communication device 120 of the supply device 5 receives the compatibility information of the power receiving device 20 from the vehicle 3. Then, the first communication device 120 of the supply device 5 transmits the compatibility information of the power transmitting device 10 to the vehicle 3. The compatibility information of the power transmitting device 10 is transmitted by wide area wireless communication. The third communication device 340 of the vehicle 3 receives the compatibility information of the power transmitting device 10 from the supply device 5. These compatibility information can be transmitted and received between the vehicle 3 and the supply device 5 by wide area wireless communication via the network 40 and the server 30.

The elements of the compatibility information that the vehicle 3 sends to the supply device 5 include vehicle identification information, WPT Power Classes, Air Gap Class, WPT Operating Frequencies, and WPT frequency adjustment, WPT Type, WPT Circuit Topology, Fine Positioning Method, Pairing Method, Alignment Method, presence/absence of power adjustment function information etc.

Elements of compatibility information that supply device 5 sends to vehicle 3 include feeder identification, WPT power class, gap class, WPT drive frequency, WPT frequency adjustment, WPT type, WPT circuit topology, detailed alignment method, It includes the pairing method, the alignment method, information on the presence or absence of the power adjustment function, and the like.

Each element name will be explained in detail. Each element of the compatibility information transmitted from the vehicle 3 to the supply device 5 will be described, and among the compatibility information transmitted from the supply device 5 to the vehicle 3, the description of compatibility information overlapping the compatibility information transmitted from the vehicle 3 to the supply device 5 will be omitted.

The gap class is information indicating a gap class from which the secondary device 22 can receive power. The WPT power class is information indicating a power class in which the secondary device 22 can receive power. The WPT drive frequency is information indicating the frequency of received power that the secondary device 22 receives. WPT frequency adjustment is information indicating whether or not the drive frequency can be adjusted. The WPT type is information indicating the shape type of the power receiving side resonance circuit 410, and indicates the coil shape of the secondary coil 21. Examples of the WTP type include circular and solenoid. The WPT circuit topology is information indicating the connection structure between the secondary coil 21 and the resonant capacitor. WTP circuit topologies include series and parallel. The detailed alignment method is information indicating by what method the alignment is to be performed. The pairing method is a method in which the vehicle 3 performs pairing to identify the supply device 5. The alignment method indicates a method of confirming the relative positions of the secondary device 22 and the primary device 13 before starting power transmission.

Fine Positioning A120 will be described. Vehicle 3 performs Fine Positioning A120 prior to Pairing and Alignment check A130 or in parallel with these activities. When the vehicle ECU 330 determines that the vehicle 3 has approached or entered the area (WPT lane) where the supply device 5 is installed, it starts Fine Positioning A120.

Vehicle ECU 330 guides vehicle 3 to align primary device 13 and secondary device 22 within a range that establishes sufficient magnetic coupling for wireless power transfer.

Fine Positioning A120 is basically performed manually or automatically on the vehicle 3 side. Fine Positioning A120 can cooperate with ADAS (Automatic Driving Assistance System).

Fine Positioning A120 activity then continues until the vehicle 3 leaves the D-WPT charging site or the state changes to end of communication, and the location data transmitted from the supply device 5 to the vehicle 3 by wide area wireless communication is It can be performed based on alignment information. This end of communication is Terminate D-WPT service session A80.

Pairing and Alignment check A130 will now be described. Here, pairing and alignment check will be explained separately.

Explain pairing. The P2PS interface for short range wireless communication ensures that the primary device 13 and the secondary device 22 are uniquely paired. The pairing state process is as follows.

First, the vehicle ECU 330 recognizes that the vehicle 3 has approached or entered the D-WPT lane. For example, the vehicle ECU 330 has map information including the D-WPT lane, and compares it with the position information of the own vehicle obtained by the GPS receiver 360 to recognize the approach or entry based on the straight line distance etc. The vehicle 3 transmits to the server 30 which D-WPT lane it has approached via wide area wireless communication. In short, the third communication device 340 notifies the cloud of a signal indicating that the vehicle 3 is approaching one of the D-WPT lanes. In addition, when the vehicle ECU 330 recognizes the approach or entry of the vehicle 3 into the D-WPT lane, the fourth communication device 350 starts transmitting the modulated signal at regular intervals for pairing the primary device 13 and the secondary device 22.

Furthermore, the supply device 5 may recognize that the vehicle 3 has approached or entered the D-WPT lane using information acquired from the server 30 through wide area wireless communication. The server 30 allocates the vehicle identification information of the vehicle 3 approaching on each D-WPT lane to the supply device 5 corresponding to that lane. Since the supply device 5 only needs to refer to the vehicle identification information whose number has been narrowed down by the server 30, the authentication process can be completed in a short time. When the supply device 5 recognizes that the vehicle 3 is approaching the D-WPT lane, the second communication device 130 goes into standby mode. In standby mode, it waits to receive a modulated signal from the fourth communication device 350 of the vehicle 3. This modulated signal includes vehicle identification information.

When the second communication device 130 receives the modulated signal from the vehicle 3, the supply device 5 transmits the vehicle identification information received through short-range wireless communication and wide-area wireless communication with the plurality of vehicles 3 approaching the D-WPT lane. The vehicle identification information in the identification information list obtained as a result is compared. By this comparison, the supply device 5 identifies the vehicle 3.

When the vehicle ECU 330 recognizes that the vehicle 3 is out of the D-WPT lane, it stops transmitting the modulated signal from the fourth communication device 350. The vehicle ECU 330 can determine whether the vehicle has passed through the D-WPT lane based on the map information and the position information of the own vehicle.

When the supply device 5 determines that the vehicle 3 is not traveling in the D-WPT lane or determines that the vehicle 3 is not approaching the D-WPT lane, the modulated signal from the fourth communication device 350 stop waiting for

Pairing is performed to the primary device 13 until the vehicle 3 exits the D-WPT charging site or the state changes to end of communication. When Pairing is complete, the state transitions to Alignment check.

The alignment check will be explained. The purpose of the alignment check is to ensure that the lateral distance between the primary device 13 and the secondary device 22 is within an acceptable range. The alignment check is performed using short range wireless communication (P2PS).

Alignment checks continue to be performed based on P2PS until the vehicle 3 leaves the D-WPT charging site or the state changes to End of Communication. The results of the alignment check can be transmitted from the first communication device 120 to the third communication device 340 via wide area wireless communication.

Magnetic Coupling Check A140 will be explained. In Magnetic Coupling Check A140, the supply device 5 confirms the magnetic coupling state and confirms that the secondary device 22 exists within the allowable range. When Magnetic Coupling Check A140 ends, the state transitions to Perform Power Transfer A150.

Perform Power Transfer A150 will be explained. In this state, the supply device 5 transmits power to the power receiving device 20. The power transmitting device 10 and the power receiving device 20 need to have the ability to control the transmitted power (transmitted power and received power) for the usefulness of the MF-D-WPT and the protection of the power receiving device 20 and the battery 320. Greater power transfer helps power receiving device 20 travel longer distances without static wireless charging and conductive charging. However, the capacity of the battery 320 varies depending on the vehicle type of the vehicle 3, and the power demand for driving may fluctuate abruptly. An example of this sudden change is sudden regenerative braking. When regenerative braking is performed while driving on the D-WPT lane, priority is given to regenerative braking, so that in addition to regenerative power, received power from power receiving device 20 is supplied to battery 320. In this case, in order to protect the battery 320 from overcharging, the power receiving device 20 needs to adjust the transmitted power.

Despite the necessity of power control, communication is not newly started between the supply device 5 and the power receiving device 20 in this state. This is because communication can impair response and accuracy in power control due to its instability and latency. Therefore, the supply device 5 and the power receiving device 20 perform power transmission and control thereof based on known information up to this state.

The supply device 5 uses wide area wireless communication in advance to increase the transmission power for the magnetic coupling check in response to the power request transmitted from the third communication device 340. The supply device 5 attempts to keep the current and voltage fluctuations within its limits while maximizing the power transferred during the transition.

The power receiving device 20 basically receives the transmitted power from the power transmitting device 10 without any control. However, the power receiving device 20 starts control when the transmitted power exceeds or is about to exceed the limit, such as the rated power of the battery 320, which varies depending on the state of charge and the power demand for driving the vehicle 3. In addition, the power control in the vehicle ECU 330 is also required to cope with malfunctions in wide area wireless communication. This malfunction leads to a contradiction between the power control target in the primary device 13 and the request from the third communication device 340, and sudden failure of the power receiving device 20 and the battery 320 during power transmission. The power receiving device 20 controls the transmitted power based on the power request rate notified by the first communication device 120.

Power requirements are determined based on compatibility check information such as vehicle 3 and primary device 13 WPT circuit topology, geometry, ground clearance, EMC (electromagnetic compatibility). The magnetic field varies depending on these specifications, and it is necessary to transmit power within a range that satisfies EMC.

Power control in power transmission ECU 110 and power receiving device 20 may interfere with each other. In particular, it may interfere if the supply device 5 attempts to achieve a power demand greater than the current power limit at the power receiving device 20 via wide area wireless communication. An example of this is rapid regeneration control using a relatively small battery 320 in the vehicle 3. If possible, it is desirable that the supply device 5 be able to detect mismatches between power control goals and limits and adjust the power transfer to resolve the mismatches.

For example, if a foreign object is detected on the primary device 13 by the foreign object detection device 140, or if the coupling coefficient of magnetic coupling becomes low due to misalignment of the secondary device 22, the secondary device 22 still remains on the primary device 13. If power transfer is briefly interrupted while on, the state transitions to Stand-by A160. Note that if the vehicle 3 is provided with a foreign object detection device, the foreign object may be detected on the vehicle 3 side.

When the secondary device 22 passes over the primary device 13, the state transitions to Power transfer terminated A170. In this case, less power is transferred because the magnetic coupling between the two devices is weaker. Since the supply device 5 can detect that the magnetic coupling has weakened by monitoring the transmitted power, the supply device 5 basically determines the state transition to Power transfer terminated A170, and then the power Start dropping voltage to stop transmission.

Stand-by A160 will be explained. In this state the power transfer is briefly interrupted for some reason and when the D-WPT is ready in both the vehicle 3 and the supply device 5 the state returns to Perform Power Transfer A150. If there is a possibility of interrupting power transfer, the state will be stand-by A160.

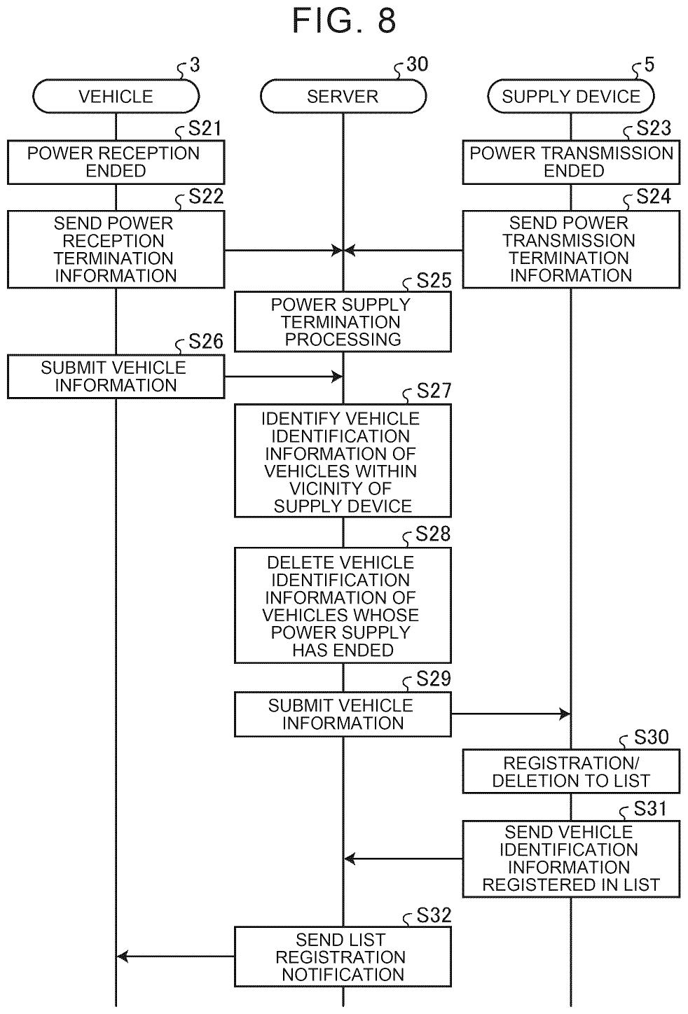

Power transfer terminated A170 will be explained. In this state, the supply device 5 reduces the transmitted power to zero and retains or uploads power transmission result data such as total transmitted power, power transmission efficiency, and failure history. Each data is tagged with vehicle identification information. Finally, the supply device 5 deletes the vehicle identification information of the vehicle 3 that has passed through the D-WPT lane. This allows the supply device 5 to be ready for subsequent pairing and power transfer to another vehicle. FIG. 8 shows the processing sequence for Power transfer terminated A170.

FIG. 8 is a sequence diagram showing the operation after the power supply from the supply device to the vehicle during running is completed. When the power receiving device 20 of the vehicle 3 finishes receiving power from the supply device 5 (S21), the vehicle 3 transmits power receiving end information to the server 30 (S22). In S22, power reception end information is transmitted from the third communication device 340 of the vehicle 3. The power reception end information includes, as information related to power reception from the supply device 5, vehicle identification information of the vehicle 3, power received from the supply device 5, power reception efficiency, and an abnormality detection result, for example.

The supply device 5 ends power transmission to the vehicle 3 when the process of S21 is performed (S23). The processing in S21 and the processing in S23 may or may not be performed simultaneously. When the process of S23 is executed, the supply device 5 transmits power transmission end information to the server 30 (S24). In S24, power transmission end information is transmitted from the first communication device 120 of the supply device 5.

When receiving the power reception end information from the vehicle 3 and the power transmission end information from the supply device 5, the server 30 performs power supply end processing for ending power supply from the supply device 5 to the vehicle 3 (S25). In the power supply termination process, based on the power reception termination information and the power transmission termination information, a process of calculating the amount of power supplied from the supply device 5 to the vehicle 3 and a process of charging the user of the vehicle 3 based on the calculated amount of supplied power are performed. It will be done.

Furthermore, the vehicle 3 transmits vehicle information to the server 30 regardless of the power supply termination process (S26). In S26, vehicle information is transmitted from the third communication device 340 of the vehicle 3.

When the server 30 receives the vehicle information from the vehicle 3 after performing the power supply termination process, the server 30 specifies the vehicle identification information of the vehicle 3 located within the vicinity of each supply device 5 based on the vehicle information (S27).

Then, if the power supply termination process for a certain vehicle 3 has already been performed in a certain supply device 5, the server 30 uses the vehicle identification information of the vehicle 3 in the vicinity area of this supply device 5 specified in the process of S27, the vehicle identification information of the vehicle 3 for which the power supply termination process has already been performed is deleted (S28).

After that, the server 30 transmits to each supply device 5 the vehicle information linked to the vehicle identification information that has not been deleted in the process of S28, among the vehicle identification information of the vehicle 3 identified as being located in the vicinity area of each supply device 5 (S29).

After the vehicle information is transmitted to each supply device 5 in the process of S29, when the supply device 5 receives the vehicle information from the server 30, the supply device 5 registers/deletes the vehicle identification information in the identification information list (S30). The process at S30 is similar to the process at S14 in FIG. 7. After that, the supply device 5 transmits the vehicle identification information registered in the identification information list to the server 30 (S31). The process at S31 is similar to the process at S15 in FIG. 7.

Then, upon receiving the vehicle identification information from the supply device 5, the server 30 transmits a list registration notification to the vehicle 3 corresponding to the vehicle identification information registered in the identification information list (S32). The process at S32 is similar to the process at S16 in FIG. 7.

As a result, when the processing shown in FIG. 8 is performed, the identification information list indicates that each supply device 5 is located in the vicinity area, that the supply device 5 has not finished supplying power, and that the vehicle identification information is registered for the vehicle 3 for which no identification information erasure request has been made. Then, when the vehicle identification information of the vehicle 3 is registered in the identification information list of any supply device 5, the vehicle 3 receives the list registration notification. Therefore, the vehicle ECU 330 can determine that the own vehicle is registered in any of the supply devices 5 by receiving the list registration notification. When the vehicle 3 moves out of the vicinity of the supply device 5, the vehicle identification information of the vehicle 3 is deleted from the identification information list of the supply device 5.

Return to FIG. 6. Further, at Power transfer terminated A170, the power receiving device 20 does not need to do anything to reduce the transmitted power to zero. The P2PS interface is kept active when the vehicle 3 is in the D-WPT lane, and the state of the power receiving device 20 automatically transitions to pairing for power transmission from the next primary device 13. The state transitions from Power transfer terminated A170 to Pairing and Alignment check A130 as the transition line shown in FIG. 6. As shown in FIG. 6, as a predetermined transition condition is satisfied, it is possible that Magnetic Coupling Check A140 transitions to Pairing and Alignment check A130, and Perform Power Transfer A150 transitions to Pairing and Alignment check A130. Pairing may be performed for each of the plurality of primary coils 11 individually, or may be performed at a representative point by bundling the plurality of primary coils 11.

In D-WPT service session A70, when there is no D-WPT request from the vehicle ECU 330, or a series of states from the Communication setup and Request D-WPT service A60 to Power transfer terminated A170 are prohibited. In this case, the process transitions to Terminate D-WPT service session A80, and the wide area wireless communication between the first communication device 120 and the third communication device 340 is stopped. For example, the D-WPT shuts down when the state of charge in battery 320 is too high or when power receiving device 20 is too hot for continuous power transfer. Such unnecessary D-WPTs can be disabled by simply deactivating the P2PS interface. However, by stopping the wide area wireless communication, the power transmission ECU 110 can terminate the established wide area wireless communication, thereby freeing up the memory occupied for the vehicle 3 without requiring the D-WPT.

Furthermore, D-WPT service session A70 is not limited to transitions like the transition line shown in FIG. 6. When D-WPT service session A70 completes the activities after Pairing and Alignment check A130, and the conditions are met for the power transfer process to remain in D-WPT service session A70, no transition to Terminate D-WPT service session A80 is made, but a transition to compatibility check and Service authentication A110 is made. For example, if a predetermined transition condition is met in state Magnetic Coupling Check A140, the state can transition to Compatibility Check and Service authentication A110. Transition of each activity in D-WPT service session A70 is controlled by the control device of the wireless power transmission system 1. The control device of wireless power transmission system 1 includes power transmission ECU 110 and vehicle ECU 330. Power transmission ECU 110 includes a function as a control device for supply device 5. Vehicle ECU 330 includes a function as a control device for power receiving device 20.

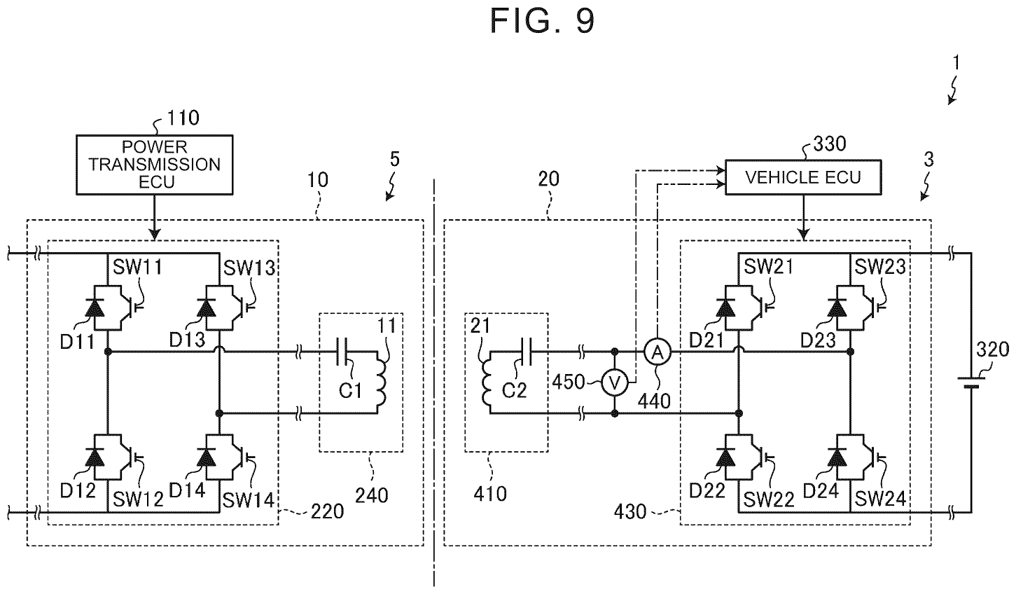

FIG. 9 is a diagram for explaining the circuit configuration of the inverter and rectifier circuit shown in FIG. 2. Note that in FIG. 9, the PFC circuit 210 and filter circuit 230 of the power transmitting device 10 are omitted, and the filter circuit 420 of the power receiving device 20 is also omitted.

The inverter 220 is constituted by a full-bridge circuit in which four switching elements SW11, SW12, SW13, and SW14 are connected in a full-bridge manner. Diodes D11 to D14 are connected in parallel to each switching element SW11 to SW14. Each of the switching elements SW11 to SW14 is composed of, for example, an IGBT or a MOSFET, and performs a switching operation in response to a control signal from the power transmission ECU 110.

The power transmitting side resonance circuit 240 includes a primary coil 11 and a resonant capacitor C1. The primary coil 11 forms an LC resonant circuit together with the resonant capacitor C1. The resonant capacitor C1 is connected in series to one end of the primary coil 11, and adjusts the resonant frequency of the LC resonant circuit on the power transmission side.

The power receiving side resonance circuit 410 includes a secondary coil 21 and a resonant capacitor C2. The secondary coil 21 forms an LC resonant circuit together with the resonant capacitor C2. The resonant capacitor C2 is connected in series with one end of the secondary coil 21, and adjusts the resonant frequency of the LC resonant circuit on the power receiving side.

The rectifier circuit 430 is constituted by a full-bridge circuit in which four diodes D21, D22, D23, and D24 are connected as rectifying elements in a full-bridge connection. One end of the filter circuit 420 is connected to the connection point between the anode of the diode D23 and the cathode of the diode D24. The other end of the filter circuit 420 is connected to the connection point between the anode of the diode D21 and the cathode of the diode D22.

A switching element is connected in parallel to each of the diodes D21, D22, D23, and D24. A switching element SW21 is connected in parallel to the diode D21. A switching element SW22 is connected in parallel to the diode D22. A switching element SW23 is connected in parallel to the diode D23. A switching element SW24 is connected in parallel to the diode D24. Each of the switching elements SW21 to SW24 is composed of, for example, an IGBT or a MOSFET, and performs a switching operation in response to a control signal from the vehicle ECU 330.

Further, the power receiving device 20 includes a current sensor 440 and a voltage sensor 450.

Current sensor 440 detects the input current of rectifier circuit 430. Current sensor 440 is provided between filter circuit 420 and rectifier circuit 430. Current sensor 440 detects the current flowing through rectifier circuit 430 and outputs the detection signal to vehicle ECU 330.

Voltage sensor 450 detects the input voltage of rectifier circuit 430. Voltage sensor 450 is provided between filter circuit 420 and rectifier circuit 430, and is connected in parallel with rectifier circuit 430. Voltage sensor 450 detects the voltage input to rectifier circuit 430 and outputs the detection signal to vehicle ECU 330.

Vehicle ECU 330 controls rectifier circuit 430 based on signals input from current sensor 440 and voltage sensor 450. For example, vehicle ECU 330 performs power control to control power supplied to battery 320 during non-contact charging. In the wireless power transmission system 1, in order to protect the load on the power receiving side, a short circuit is formed using switching elements SW21 to SW24 of the power receiving device 20 during non-contact charging, and the amount of power supplied to the load is suppressed. Vehicle ECU 330 executes power control during non-contact charging and controls each switching element SW21 to SW24 of rectifier circuit 430.

Power control includes diode mode and short circuit mode. Vehicle ECU 330 can switch between diode mode and short circuit mode.

The diode mode is a control in which current flows to the battery 320 and received power is supplied from the power receiving device 20 to the battery 320. In the diode mode, all switching elements SW21, SW22, SW23, and SW24 of the rectifier circuit 430 are controlled to be in the off state. The current path in the diode mode is a return path via the diode D23, the battery 320, and the diode D22 in this order.

The short circuit mode is a control in which the current flows back and no current flows into the battery 320. The short circuit mode is a mode in which current flows back from the rectifier circuit 430 to the secondary coil 21 side. In the short circuit mode, the switching element SW21 of the rectifier circuit 430 is controlled to be in the on state, and the switching elements SW22, SW23, and SW24 are controlled to be in the off state. The current path in the short-circuit mode is a return path via the diode D23 and the switching element SW21 in this order. Vehicle ECU 330 executes a short circuit mode in which a switching element provided between secondary coil 21 and a load is operated to short-circuit the output terminals of secondary coil 21.

By having vehicle ECU 330 execute the short circuit mode, the amount of power supplied to battery 320 can be reduced. Vehicle ECU 330 executes control to switch between diode mode and short circuit mode when reducing the power received by battery 320. Vehicle ECU 330 executes switching control to switch switching element SW21 between an OFF state and an ON state.

Further, the vehicle ECU 330 controls the duty, which is the proportion of the short circuit mode in the voltage rectangular wave, from 0 to 100% (duty ratio from 0 to 1). Vehicle ECU 330 controls the magnitude of power received by battery 320 by manipulating the duty of the short circuit mode.

In the wireless power transmission system 1 configured in this way, the vehicle ECU 330 executes power control during non-contact charging to suppress an increase in the power of the battery 320 and protect the battery 320. For example, if regenerative braking and non-contact charging are performed simultaneously while the vehicle 3 is running, excessive power will be supplied to the battery 320, which may lead to deterioration or failure of the battery 320. To prevent this, the vehicle ECU 330 performs power control to reduce the received power due to non-contact charging. In other words, vehicle ECU 330 gives priority to regenerative braking and controls to refrain from non-contact charging.

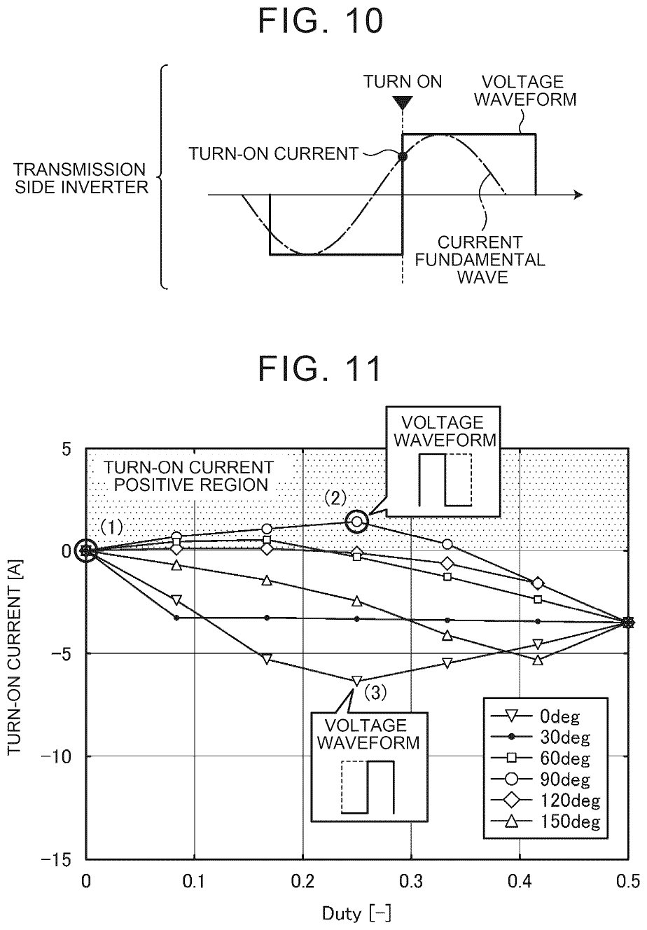

Furthermore, in the wireless power transmission system 1, when power control is executed on the vehicle 3 side, the influence extends to the supply device 5 on the ground side. As a result, a turn-on current is generated in the inverter 220 on the ground side, as shown in FIG. 10. The turn-on current is the output current of the inverter 220 when the output voltage of the inverter 220 rises. If a positive turn-on current is generated in the inverter 220, the elements of the inverter 220 will have adverse effects such as heat generation and noise. The positive turn-on current means that the current flowing through the inverter 220 when the voltage of the inverter 220 rises is positive. When a positive turn-on current flows, a reverse short-circuit current (recovery current) flows through diode D13 when the output voltage of inverter 220 rises. In this case, the diode D13 through which the recovery current flows and the switching element SW13 generate more heat, and the loss of the inverter 220 increases. On the other hand, if the turn-on current is zero or less, no recovery current flows through diode D13 of inverter 220, and the loss of inverter 220 can be reduced. Therefore, in the wireless power transmission system 1, power control is executed in the vehicle 3 on the power receiving side so as to prevent the turn-on current on the power transmitting side from becoming positive.

As shown in FIG. 11, the value of the power transmission-side turn-on current changes under the influence of power control being executed in the power-receiving-side vehicle 3. The turn-on current may be zero, positive, or negative. Therefore, vehicle ECU 330 on the power receiving side executes the short circuit mode so as to avoid a region where the turn-on current on the power transmitting side is positive.

Note that the duty shown on the horizontal axis in FIG. 11 represents the duty of switching control (PWM control) on the power receiving side. Moreover, in FIG. 11, when the duty is 0, it represents no short-circuit mode, and when the duty is 0.5, it represents the case where all periods are short-circuited.

When the vehicle ECU 330 executes the short circuit mode and a short circuit is formed in the rectifier circuit 430, a period occurs in which the voltage rectangular wave of the rectifier circuit 430 becomes zero, and the voltage fundamental wave of the rectifier circuit 430 is pushed left and right. There are cases where a phase shift occurs. The phase shift includes a direction in which the phase of the voltage fundamental wave of the rectifier circuit 430 is advanced and a direction in which the phase of the voltage fundamental wave in the rectifier circuit 430 is delayed.

The voltage waveform (voltage rectangular wave) is a waveform that includes two peaks (a positive voltage peak and a negative voltage peak) in one cycle. In this explanation, with respect to one peak of the voltage rectangular wave, the left side is called the phase leading side, and the right side is called the phase lagging side. When it is described as the right side of the voltage rectangular wave, it refers to both the right side of the positive voltage peak and the right side of the negative voltage peak. When described as the left side of the voltage rectangular wave, it refers to both the left side of the positive voltage peak and the left side of the negative voltage peak.

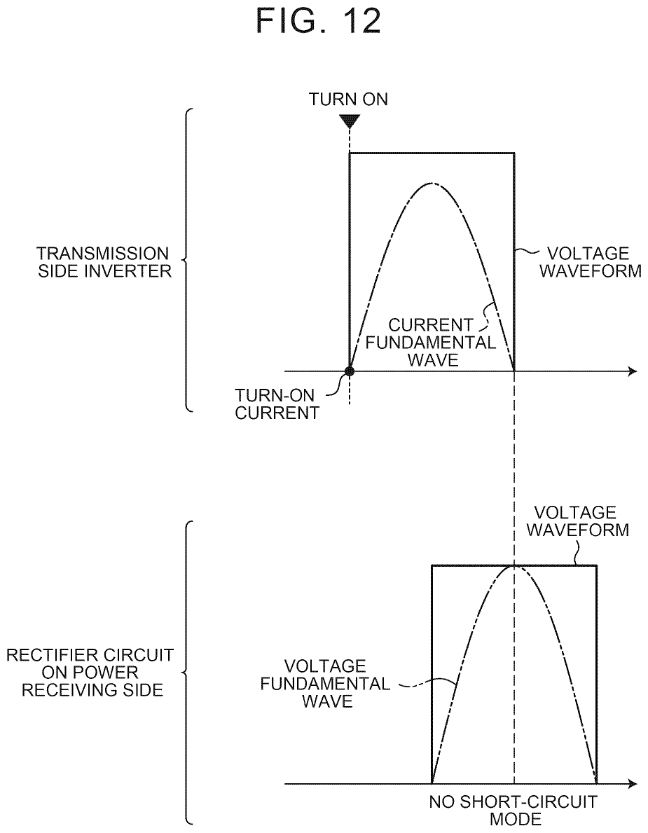

The relationship between the voltage rectangular wave on the power receiving side and the turn-on current on the power transmitting side will be described with reference to FIGS. 12 to 14.

FIG. 12 is a diagram for explaining a case where there is no short circuit on the power receiving side and the turn-on current on the power transmitting side becomes zero. FIG. 12 shows a case where power control is not executed (short circuit mode) on the power receiving side, that is, a case where diode mode is executed. As shown in FIG. 12, when the rectifier circuit 430 on the power receiving side is controlled to the diode mode and no short circuit is formed, the voltage rectangular wave of the rectifier circuit 430 is not shaved. In this case, in the power transmitting side inverter 220, the timing at which the output voltage and the output current cross zero coincide with each other, so the turn-on current becomes zero.

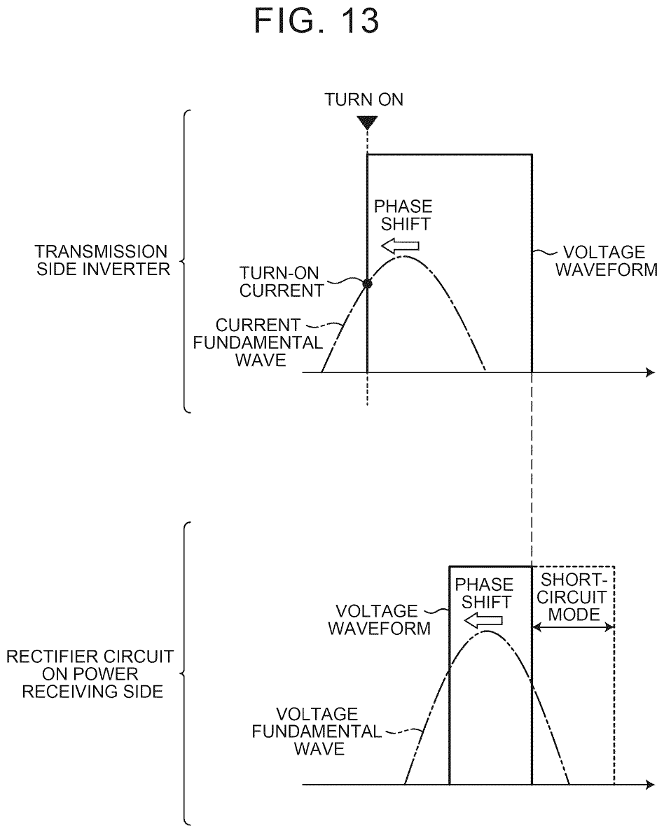

FIG. 13 is a diagram for explaining a case where there is a short circuit on the power receiving side and the turn-on current on the power transmitting side is positive. As shown in FIG. 13, when power control is executed by setting the short-circuit phase so as to cut the right side (lag side) of the voltage rectangular wave in the rectifier circuit 430 on the power receiving side, the voltage fundamental wave of the rectifier circuit 430 changes to the left side (lead side). A phase shift occurs as if it were pushed out to the side. When the phase of the voltage fundamental wave on the power receiving side shifts to the leading side, the effect extends to the power transmitting side. As a result, as the phase of the voltage of the rectifier circuit 430 advances, the phase of the current of the inverter 220 on the power transmission side also advances, which leads to the turn-on current on the power transmission side becoming positive. The phase of the inverter current shown in FIG. 13 is ahead of the phase of the inverter current shown in FIG. 12. Furthermore, the fact that the turn-on current is positive when the inverter output voltage rises corresponds to the fact that the phase of the output current in the inverter 220 is advanced with respect to the output voltage.

Therefore, vehicle ECU 330 executes the short circuit mode in such a way as to avoid the situation shown in FIG. 13. In other words, vehicle ECU 330 executes the short-circuit mode so as to avoid a region where the phase of the current of power transmitting side inverter 220 is advanced.

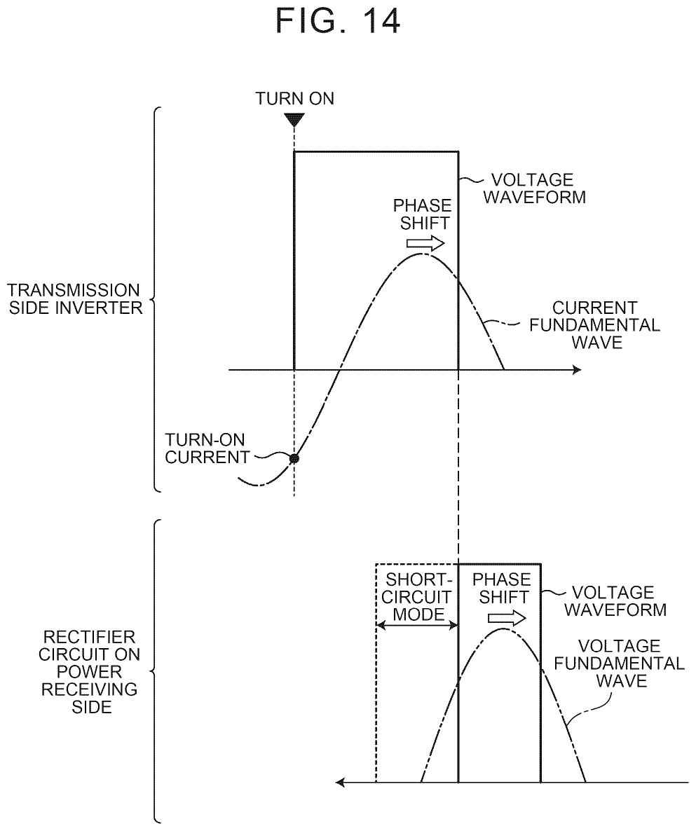

FIG. 14 is a diagram for explaining a case where there is a short circuit on the power receiving side and the turn-on current on the power transmitting side becomes negative. As shown in FIG. 14, when power control is performed by setting the short-circuit phase to cut the left side (advanced side) of the voltage rectangular wave in the rectifier circuit 430 on the power receiving side, the voltage fundamental wave of the rectifier circuit 430 changes to the right side (delayed side). A phase shift occurs as if it were pushed out to the side. When the phase of the voltage fundamental wave on the power receiving side shifts to the delayed side, the effect extends to the power transmitting side. As a result, as the phase of the voltage of the rectifier circuit 430 is delayed, the phase of the current of the inverter 220 on the power transmission side is also delayed, which leads to the turn-on current on the power transmission side becoming negative. The phase of the inverter current shown in FIG. 14 lags behind the phase of the inverter current shown in FIG. 12.

In this way, vehicle ECU 330 controls the switching timing (short circuit phase) for forming a short circuit during non-contact charging to a phase in which the turn-on current on the power transmission side does not become positive. To this end, the charging control unit 630 of the vehicle ECU 330 executes the short circuit mode with a first detection unit that detects the phase of the current in the rectifier circuit 430 and a second detection unit that detects the phase of the voltage in the rectifier circuit 430. The present disclosure includes a determination unit that determines whether the short circuit phase occurs, a determination unit that determines the short circuit phase, and a control unit that executes power control according to the short circuit phase.

The first detection unit detects the phase of the current on the input side of the rectifier circuit 430 based on the signal input from the current sensor 440. Current sensor 440 functions as a sensor for detecting the phase of current. The first detection unit detects the phase of the current flowing into the rectifier circuit 430 in real time.

The second detection unit detects the phase of the voltage on the input side of the rectifier circuit 430 based on the signal input from the voltage sensor 450. Voltage sensor 450 functions as a sensor for detecting the phase of voltage. The second detection unit detects the phase of the voltage input to the rectifier circuit 430 in real time.

The determining unit determines whether there is a situation where it is necessary to protect the load on the power receiving side. If it is determined that there is a situation in which it is necessary to protect the load on the power receiving side, it is determined that the short circuit mode is to be executed. Specifically, the determination unit determines whether regenerative braking is performed during non-contact charging. As an example, the determination unit determines whether regenerative braking is performed in the state of Perform Power Transfer A150 while the vehicle 3 is traveling on the D-WPT lane.

When the determination unit determines to execute the short circuit mode, the determination unit determines the phase in which the turn-on current on the power transmission side is positive based on the phase of the voltage detected by the second detection unit as the phase of the short circuit mode (short circuit phase) is determined. The short circuit phase is determined so that the phase shift caused by executing the short circuit mode is on the phase lag side.

The control unit performs power control based on the short circuit phase determined by the determination unit. If it is determined that the short-circuit mode is to be executed, the vehicle ECU 330 determines the short-circuit phase so that the left side (phase leading side) of the voltage rectangular wave is largely removed, and executes the short-circuit mode based on this determined short-circuit phase.

When the vehicle ECU 330 executes power control (short circuit mode) in which the left side of the voltage rectangular wave is largely reduced (short-circuit mode), the voltage fundamental wave in the rectifier circuit 430 undergoes a phase shift in the lag direction, as shown in FIG. 14. Along with this phase shift of the voltage fundamental wave on the power receiving side, the current fundamental wave in the power transmitting side inverter 220 undergoes a phase shift in the delay direction. As a result, the turn-on current on the power transmission side becomes negative.

As described above, according to the embodiment, when performing power control using the switching element provided in the power receiving device 20, it is possible to suppress the turn-on current on the power transmission side from becoming positive. Thereby, when performing non-contact charging, it is possible to protect the load on the power receiving side, and at the same time, it is possible to protect the elements on the power transmitting side.

Note that current sensor 440 may detect the phase of the current and output the detection signal to vehicle ECU 330. Vehicle ECU 330 obtains information regarding the phase of the current included in the signal from current sensor 440.

Moreover, the installation locations of current sensor 440 and voltage sensor 450 are not particularly limited. Vehicle ECU 330 only needs to be able to acquire current value information that allows estimating the current of rectifier circuit 430, and the connection location of current sensor 440 is not particularly limited. Similarly, vehicle ECU 330 only needs to be able to acquire voltage information that allows estimating the voltage applied to rectifier circuit 430, and the connection location of voltage sensor 450 is not particularly limited.

Further, in the rectifier circuit 430, switching elements may not be connected in parallel to all diodes. For example, in the case where the rectifier circuit 430 has a switching element connected in parallel to the diode D21 and the diode D23, the switching element does not need to be connected in parallel to the diode D22 and the diode D24. Alternatively, in the case where the rectifier circuit 430 has a switching element connected in parallel to the diode D22 and the diode D24, the switching element does not need to be connected in parallel to the diode D21 and the diode D23.

Moreover, the non-contact charging is not limited to the case where the vehicle 3 is running, but the non-contact charging can be performed while the vehicle 3 is stopped. The vehicle ECU 330 can execute the short circuit mode by controlling the switching elements of the rectifier circuit 430 when contactlessly receiving power from the power transmitting device 10 on the ground side while the vehicle 3 is stopped.

Further, when vehicle ECU 330 is in the short circuit mode, the switching timing of the switching element is not limited to the case where only the left side of the voltage rectangular wave is shaved or the case where only the right side of the voltage rectangular wave is shaved. In short, the vehicle ECU 330 can set the short-circuit phase so that the left side of the voltage rectangular wave is shaved more than the right side, and can also set the short-circuit phase so that the right side of the voltage rectangular wave is shaved more than the left side. When executing the short circuit mode, the vehicle ECU 330 can determine the switching timing of the switching elements of the rectifier circuit 430 so that the left side of the voltage rectangular wave is shaved more than the right side.

What is claimed is:

1. A control device for a power receiving device including a power receiving coil that receives power transmitted from a power transmitting coil of the power transmitting device in a contactless manner, wherein when the control device performs a short-circuit mode in which a switching element provided between the power receiving coil and a load is operated to short-circuit a portion between output terminals of the power receiving coil, the control device performs the short-circuit mode such that a region in which a phase of a current in an inverter of the power transmitting device is advanced is avoided.

2. The control device according to claim 1, wherein the control device determines a switching timing of the switching element in the short-circuit mode such that, by executing the short-circuit mode, the phase of the current of the inverter is shifted in a direction in which the phase of the current of the inverter is delayed.

3. The control device according to claim 1, wherein when the control device performs the short-circuit mode, the control device controls a swing timing of the switching element in the short-circuit mode such that a left side of a voltage rectangular wave on a power receiving side is trimmed more than a right side of the voltage rectangular wave on the power receiving side is trimmed.
